(19) United States
(12) Patent Application Publication
(10) Pub. No.: US 2025/0331538 A1
(43) Pub. Date: Oct. 30, 2025

(54) MALLEABLE CONSUMABLE PRODUCT FOR ANIMALS AND METHODS OF MANUFACTURE THEREOF

(71) Applicant: BIG HEART PET, INC., Orrville, OH (US)

(72) Inventors: Kenneth James Byers, Akron, OH (US); Chad Aaron Jasiunas, Akron, OH (US); Stephen Thomas Michalak, Broadview Heights, OH (US); Katrina Marie Rodriguez, Copley, OH (US); David Kwaku Asiamah, Medina, OH (US)

(73) Assignee: BIG HEART PET, INC., Orrville, OH (US)

(21) Appl. No.: 19/193,122

(22) Filed: Apr. 29, 2025

Related U.S. Application Data
(60) Provisional application No. 63/640,440, filed on Apr. 30, 2024.

(51) Int. Cl. A23K 10/30; A23K 10/20; A23K 20/105; A23K 20/111; A23K 20/121; A23K 20/132; A23K 20/137; A23K 20/158; A23K 20/163; A23K 40/25; A23K 50/45

(52) U.S. Cl. CPC A23K 10/30; A23K 10/20; A23K 20/105; A23K 20/111; A23K 20/121; A23K 20/132; A23K 20/137; A23K 20/158; A23K 20/163; A23K 40/25; A23K 50/45

(57) ABSTRACT

A soft and malleable (non-crumbly) consumable pet treat is provided. The pet treat has a peanut butter-like color. The pet treat comprises a substantially homogenous matrix comprising native and modified wheat starch, peanut flour, peanut butter, a liquid sweetener and a humectant, where the matrix binds or retains oil of peanut butter, so the treat does not have an oily or sticky surface. The homogenous texture matrix can be enriched in volatile compounds, which emit savory aromas. The pet treat has sufficient moisture to maintain the soft and malleable (non-crumbly) texture after packaging and throughout normal distribution to the end user. The pet treat is shelf stable and avoids spoilage, i.e., bacteria or fungal growth. The pet treat remains intact and does not excessively agglomerate in packaging. The pet treat can be unpackaged and handled without exposure to a bothersome sticky, oily, and/or crumbly mess.

### CROSS REFERENCE TO RELATED APPLICATION

This application claims the priority and benefit of U.S. Provisional Application No. 63/640,440, filed Apr. 30, 2024, the entirety of which is incorporated by reference herein.

### FIELD OF THE INVENTION

The invention relates to a malleable consumable product for animals that is manufactured by an extrusion process. More specifically, the invention provides a malleable consumable having a soft, chewable texture matrix, wherein the malleable consumable provides a delivery system of peanut butter coupled with a distinct peanut butter-like aroma derived from volatile compounds enriched in the texture matrix that forms the malleable consumable, without the mess associated with feeding traditional peanut butter and other peanut butter snacks.

### BACKGROUND OF THE INVENTION

Pet owners like to feed treats to their pets, particularly treats that provide health benefits. Peanut butter is a good source of healthy fats, protein, Vitamins B and E, minerals, and fiber. Peanut butter can provide potential health benefits for pets. In addition to potential health benefits, peanut butter can be used with interactive toys for pet engagement and can be useful to conceal pills, which a pet may otherwise not consume.

Food aromas and flavors directly correlate with the presence of volatile compounds, i.e., compounds with high vapor pressure, in the food. In the pet food industry, aromas and flavors play a key role. For example, dogs have a powerful sense of smell resulting from about 300 million olfactory receptors in their noses (compared to about 6 million in humans). It has been estimated that dogs can detect tens of thousands to potentially over 100,000 distinct aromas. In comparison, cats have a highly developed sense of smell resulting from, on average, about 50 to 80 million olfactory receptors in their noses. It is estimated that cats can distinguish between tens of thousands distinct aromas. Pets use their highly developed sense of smell to detect aromas of food that they want to eat.

Feeding peanut butter to pets is difficult because of the stickiness and oiliness of peanut butter, which can create a mess. Manufacturers have attempted to create solutions for sticky and oily pet consumables with various peanut butter treats for pets. These solutions do not address the problems with using peanut butter in pet consumables. For example, some peanut butter treats have a crumbly texture that creates crumbs or simply falls apart. Other peanut butter treats exhibit significant oil separation, i.e., a high amount of surface oil residue and/or oil transference when the treat contacts a surface. Some peanut butter treats are sticky and agglomerate with one another inside a package. The moisture in some peanut butter treats contribute to microbial contamination. Finally, some peanut butter treats for pets have aromas, which are inconsistent with the aroma of peanut butter. Manufacturers have not been able to develop a peanut butter-based pet treat, which exhibits a peanut butter-like aroma and that is not messy, sticky, or overly oily.

Accordingly, there is a need for a soft and malleable pet treat comprising peanut butter. There is a further need for such a pet treat having a bite size shape, which is operationally efficient (i.e., a square or rectangular cube, etc.) and has a color like that of peanut butter and an aroma like that of peanut butter. There is a further need for such a pet treat capable of remaining intact and not excessively agglomerating in a package through normal distribution from a manufacturer to the consumer. There is an additional need for such a pet treat having sufficient moisture to maintain a soft and malleable texture after being packaged and throughout normal distribution, and that is shelf stable, while avoiding spoilage (i.e., bacteria or fungal growth). Finally, there is a need for such a pet treat, which consumers can easily remove from a package and handle without exposure to a bothersome sticky, oily, and/or crumbly mess.

### SUMMARY OF THE INVENTION

To achieve solutions for the foregoing needs and to provide other advantages, and according to the purpose of the invention as embodied and described herein, the invention provides an easier, less messy way to deliver peanut butter treats to a pet by providing a soft and malleable (non-crumbly) animal consumable, i.e., pet treat, comprising peanut butter and an enticing aroma.

The pet treat has a bite size shape that is functionally efficient (i.e., a square or rectangular cube, etc.), a color like that of traditional peanut butter, and an aroma like that of traditional peanut butter or, alternatively, of a combination of traditional peanut butter, bacon, and smoke.

The texture of the pet treat is important. The texture of the pet treat contributes to its functionality, to its appeal as being chewable, to having an aroma enticing for animals, and to its low surface oil and low surface adhesion, i.e., stickiness, which is desirable by humans for use.

The pet treat does not agglomerate with other pet treats in packaging while traveling through normal distribution channels. The pet treat includes a level of moisture sufficient to maintain a soft and malleable (non-crumbly) texture after being packaged and throughout normal distribution. The pet treat is shelf stable and avoids spoilage (i.e., bacteria or fungal growth). Finally, the pet treat can be removed from a package and handled without exposure to a bothersome sticky, oily, and/or crumbly mess.

The texture of the pet chew is provided by the formulas used to make the pet treat with an extrusion process.

A pet treat is provided and comprises a homogeneous, malleable (non-crumbly) composition made from pregelatinized wheat flour at about 5-15 weight percentage (wt %) of the pet treat; wheat flour at about 15-30 wt % of the pet treat; liquid sweetener at about 2-11 wt % of the pet treat; peanut butter at about 9-18 wt % of the pet treat; peanut flour 0-25 wt % of the pet treat; water at about 15-18 wt % of the pet treat; and a humectant at about 15-26.5 wt % of the pet treat.

Another pet treat is provided and comprises a homogeneous, malleable (non-crumbly) composition made from wheat flour at about 10-15 wt % of the pet treat; liquid sweetener at about 20-25 wt % of the pet treat; peanut butter at about 17-20 wt % of the pet treat; peanut flour at about 0-25 wt % of the pet treat; rolled oats at about 3 wt % of the pet treat; and a humectant at about 15-26.5 wt % of the pet treat.

A further pet treat is provided and comprises a homogeneous, malleable (non-crumbly) composition made from wheat flour at about 22-30 wt % of the pet treat; liquid sweetener at about 20-25 wt % of the pet treat; peanut butter at about 17-20 wt % of the pet treat; rolled oats at about 3 wt % of the pet treat; and a humectant at about 15-26.5 wt % of the pet treat.

Yet another pet treat is provided and comprises a homogeneous, malleable (non-crumbly) composition made from wheat flour at about 22-30 wt % of the pet treat; liquid sweetener at about 22-25 wt % of the pet treat; peanut butter at about 17-20 wt % of the pet treat; peanut flour at about 6-10 wt % of the pet treat; rolled oats at about 3 wt % of the pet treat; and a humectant at about 15-26.5 wt % of the pet treat.

The pet treat has a ratio of pregelatinized wheat flour to liquid sweetener in a range of about 1.5:1 to 5:1, about 2.5:1 to about 0.8:1, about 1.77:1 to about 0.5:1, about 1.6:1 to about 1.5:1, about 1:0.7 to about 1:1.4; or about 1:0.7-1:0.95.

The pet treat has a ratio of humectant to wheat flour in a range of about 1.77:1 to about 0.5:1, about 1:0.7 to about 1:1.4; or about 1:0.7 to about 1:0.95.

The pet treat has a ratio of humectant to pregelatinized wheat flour in a range of about 0.5:1 to about 1.77:1, about 0.5:1 to about 2.4:1, about 0.5:1 to about 1.44:1, about 1:0.2 to about 1:0.7, or about 2.2:1 to 2.4:1.

The pet treat comprises a moisture content of up to about 24%. The pet treat comprises water activity in a range from about 0.65 to about 0.73.

The pet treat has a surface with low adhesiveness.

The pet treat has a surface with low oil. The texture matrix of the pet treat substantially retains the oil of the peanut butter by binding the oil with native starch of wheat flour or modified starch of pregelatinized wheat flour or by retaining the oil within the matrix by way of interaction of the liquid sweetener and humectant. The texture matrix of the pet treat minimizes or eliminates oil transference between the pet treat and any surface it contacts.

A pet treat can be made by a method that comprises the steps of (1) blending dry ingredients comprising wheat flour, pregelatinized wheat flour, and peanut flour to form a dry mixture; (2) mixing wet ingredients comprising water, humectant, peanut butter, and liquid sweetener to form a wet mixture; (3) combining the dry mixture and the wet mixture with a mixer to create a substantially homogenous dough; and (4) subjecting the homogenous dough to heat treatment in a cook cycle and extruding the cooked dough to produce the composition formed into the pet treat.

The pet treat is enriched in volatile compounds that emit a distinct peanut butter-like aroma or a distinct aroma of peanut butter, bacon and smoke.

The pet treat has one or more of the volatile compounds selected from the group consisting of pyrazines, 4-dimethylthiazole, maltol, and acetoin. The pet treat has a ratio content of pyrazines to maltol that is greater than 200. The pet treat has a ratio content of 4-methylthiazole to acetoin is greater than 0.8.

The pet treat is enriched in one or more of the volatile compounds selected from the group consisting of p-cresol, pyridine, cucalyptol, and benzyl alcohol. The pet treat has a ratio content of p-cresol to cucalyptol is greater than 20. The pet treat has a ratio content of pyridine to benzyl alcohol is greater than 5.

In summary, the solutions of the invention provide a malleable animal consumable providing the nutritional benefits of peanut butter without the sticky and/or oily mess associated with peanut butter. This results in a malleable animal consumable that does not agglomerate or spoil inside the package, while it exhibits a peanut butter-like aroma and is shelf stable. These advantages are derived from the unique compositions used to form the pet treat.

### BRIEF DESCRIPTION OF THE FIGURES

The patent or application file contains at least one drawing executed in color. Copies of this patent or patent application publication with color drawing(s) will be provided by the Office upon request and payment of the necessary fec.

Additional aspects, features, and advantages of the invention, as to its structure, composition, and methods will be understood and become clearer when the invention is considered in view of the following brief description of the figures made in conjunction with the accompanying drawings, wherein:

FIG. 1 shows a front perspective view of a pet treat without inclusions, i.e., PB Bite, of the invention.

FIG. 2 shows a front perspective view of a pet treat with bacon inclusions, i.e., PBB Bite, of the invention.

FIGS. 3A through 3J show qualitative results of texture testing (before and after testing) of the PB Bite of the invention (made with the formula of Table 1) and other pet products on the market incorporating peanut butter or peanut butter flavor as an ingredient, including Hill's Natural Soft Savories (Hill's Pet Nutrition) shown in FIGS. 3A, 3B; Zuke's Mini Naturals (Zuke's Performance Pet Nutrition) shown in FIGS. 3C, 3D; Greenies Pill Pockets (Mars Petcare) shown in FIGS. 3E, 3F; PB Bite of the invention shown in FIGS. 3G, 3H; and Blue Dog Bakery Softies (Blue Dog Bakery) shown in FIGS. 31, 3J.

FIG. 4A shows quantitative results of oneway analysis of hardness testing, while FIG. 4B shows quantitative results of oneway analysis of adhesiveness (or stickiness) testing, of the PB Bite and other pet products on the market incorporating peanut butter or peanut butter flavor as an ingredient, including Hill's Natural Soft Savories (Hill's Pet Nutrition), Zuke's Mini Naturals (Zuke's Performance Pet Nutrition), PB Bite of the invention, Greenies Pill Pockets (Mars Petcare), and Blue Dog Bakery Softies (Blue Dog Bakery).

FIGS. 5A-5N show qualitative results of the testing of oil transference from a pet consumable product incorporating peanut butter or peanut butter flavor as an ingredient, to filter paper where the pet products include Hill's Natural Soft Savories (Hill's Pet Nutrition) shown in FIGS. 5A, 5B, Greenies Pill Pockets (Mars Petcare) shown in FIGS. 5C, 5D; Zuke's Mini Naturals (Zuke's Performance Pet Nutrition) shown in FIGS. 5E, 5F; Blue Dog Bakery Softies (Bluc Dog Bakery) shown in FIGS. 5G, 5H; PB Bite of the invention shown in FIGS. 51, 5J; Jimbo's Jumbo Peanut Butter (Hampton Farms) shown in FIGS. 5K, 5L; and JIF Creamy Peanut Butter (The J.M. Smucker Company) shown in FIGS. 5M, 5N. FIG. 5O shows a oneway analysis of oil leached (% of total weight of product) of the PB Bite of the invention and JIF Creamy Peanut Butter (The J.M. Smucker Company).

FIG. 6 shows a manufacturing process for the pet treat of the invention.

FIG. 7 plots the total amount of pyrazines (as area content), which were (i) extracted from the PB Bites and the PBB Bites (with bacon inclusions) of the invention, and other pet products on the market incorporating peanut butter or peanut butter flavor as an ingredient, including Beggin' Strips with bacon and peanut flavor (Nestlé Purina PetCare, C1), Blue Dog Bakery Softies with peanut butter flavor (Blue Dog Bakery, C2), Bocce's Soft & Chewy peanut butter and banana (Bocce's Bakery, C3), and Zuke's Mini Naturals with peanut butter and oats (Zuke's Performance Pet Nutrition, C4), and then (ii) determined with gas chromatography-mass spectrometry (GC/MS) with measurements shown on Table 9.

FIG. 8 plots the ratio of the area content of total pyrazine compounds to maltol, which were (i) extracted from the PB Bites and the PBB Bites (with bacon inclusions) of the invention, and other pet products on the market incorporating peanut butter or peanut butter flavor as an ingredient, including Beggin' Strips with bacon and peanut flavor (Nestlé Purina PetCare, C1), Blue Dog Bakery Softies with peanut butter flavor (Blue Dog Bakery, C2), Bocce's Soft & Chewy peanut butter and banana (Bocce's Bakery, C3), and Zuke's Mini Naturals with peanut butter and oats (Zuke's Performance Pet Nutrition, C4), and then (ii) determined with gas chromatography-mass spectrometry (GC/MS) with measurements shown on Table 10.

FIG. 9 shows the ratio of the area content of 4-methylthiazole to acetoin, which were (i) extracted from the PB Bites and the PBB Bites (with bacon inclusions) of the invention, and other pet products on the market incorporating peanut butter or peanut butter flavor as an ingredient, including Beggin' Strips with bacon and peanut flavor (Nestlé Purina PetCare, C1), Blue Dog Bakery Softies with peanut butter flavor (Blue Dog Bakery, C2), Bocce's Soft & Chewy peanut butter and banana (Bocce's Bakery, C3), and Zuke's Mini Naturals with peanut butter and oats (Zuke's Performance Pet Nutrition, C4), and then (ii) determined with gas chromatography-mass spectrometry (GC/MS) with measurements shown on Table 10.

FIG. 10 shows the ratio of the area content of p-cresol to eucalyptol, which were (i) extracted from the PB Bites and the PBB Bites (with bacon inclusions) of the invention, and other pet products on the market incorporating peanut butter or peanut butter flavor as an ingredient, including Beggin' Strips with bacon and peanut flavor (Nestlé Purina PetCare, C1), Blue Dog Bakery Softies with peanut butter flavor (Blue Dog Bakery, C2), Bocce's Soft & Chewy peanut butter and banana (Bocce's Bakery, C3), and Zuke's Mini Naturals with peanut butter and oats (Zuke's Performance Pet Nutrition, C4), and then (ii) determined with gas chromatography-mass spectrometry (GC/MS) with measurements shown on Table 11.

FIG. 11 shows the ratio of the area content of pyridine to benzyl alcohol, which were (i) extracted from the PB Bites and the PBB Bites (with bacon inclusions) of the invention, and other pet products on the market incorporating peanut butter or peanut butter flavor as an ingredient, including Beggin' Strips with bacon and peanut flavor (Nestlé Purina PetCare, C1), Blue Dog Bakery Softies with peanut butter flavor (Blue Dog Bakery, C2), Bocce's Soft & Chewy peanut butter and banana (Bocce's Bakery, C3), and Zuke's Mini Naturals with peanut butter and oats (Zuke's Performance Pet Nutrition, C4), and then (ii) determined with gas chromatography-mass spectrometry (GC/MS) with measurements shown on Table 11.

FIG. 12 is a chromatogram of one replicate of each analyzed sample showing the extracted ion chromatogram of m/z=94, representative of the volatile compound methylpyrazinc. The average integrated area under the curve measured for these samples is shown in Table 9. The analyzed samples include the PB Bites and the PBB Bites (with bacon inclusions) of the invention, and other pet products on the market incorporating peanut butter or peanut butter flavor as an ingredient, including Beggin' Strips with bacon and peanut flavor (Nestlé Purina PetCare, C1), Blue Dog Bakery Softies with peanut butter flavor (Blue Dog Bakery, C2), Bocce's Soft & Chewy peanut butter and banana (Bocce's Bakery, C3), and Zuke's Mini Naturals with peanut butter and oats (Zuke's Performance Pet Nutrition, C4).

FIG. 13 is a chromatogram of one replicate of each analyzed sample showing the extracted ion chromatogram of m/z=107, representative of the volatile compound ethylpyrazine. The average integrated area under the curve measured for these samples is shown in Table 9. The analyzed samples included the PB Bites and the PBB Bites (with bacon inclusions) of the invention, and other pet products on the market incorporating peanut butter or peanut butter flavor as an ingredient, including Beggin' Strips with bacon and peanut flavor (Nestlé Purina PetCare, C1), Blue Dog Bakery Softies with peanut butter flavor (Blue Dog Bakery, C2), Bocce's Soft & Chewy peanut butter and banana (Bocce's Bakery, C3), and Zuke's Mini Naturals with peanut butter and oats (Zuke's Performance Pet Nutrition, C4).

### DETAILED DESCRIPTION OF THE INVENTION

Pet owners often seek to provide for the well-being of animals within their care. Pets tend to cat consumables that they like. Pet owners like to provide their pets with consumables that provide nutrition to support the health of their pet. Consumable articles can be made with tastes, textures, and aromas that appeal to pets. Illustrative embodiments of a pet treat comprised of a malleable (non-crumbly) composition with peanut butter are described in detail with reference being made to the figures of this application. While similar aspects of embodiments of the invention are featured throughout this disclosure, these similarities may be repeated within the context of the various embodiments of the invention.

### Definitions

As used herein, each of the following terms has the meaning associated with it in this section.

The term “chewable” refers to the texture and organoleptic properties of an animal consumable product, which tend to promote chewing of the pet treat by an animal. The “chewable” animal consumable product of the invention exhibits (i) sufficient ductility and is malleable when bitten by a pet, (ii) sufficient textural integrity and does not crumble when bitten by the animal the first time, even though it will break apart over the course of multiple bites, and (iii) sufficient aroma such that a pet is not deterred by its smell.

The terms “texture” or “texture matrix” refer to the rheological, organoleptic, and structural attributes of the animal consumable product of the invention, which are perceptible by sensory experiences originated from receptors of animals during the eating process of the animal food product and/or of animals or humans contacting the animal consumable product. Texture and structure are linked properties of animal consumable products. Texture largely correlates with the oral sensory perception of an animal while eating, primarily in the form of biting, chewing, etc., that involves deformation, fracture, and breakage of food, and can directly relate to the density, composition, physical structure, moisture content, and mechanical properties of the animal consumable product. The animal consumable product can be referred to in this specification generally as a “pet treat”. Non-limiting examples of the “pet treat” include pet treats specifically referred to as “PB Bite”, which are made according to the formula of Table 1, and pet treats with bacon inclusions specifically referred to as “PBB Bite”, which are made according to the formula of Table 2.

The term “shelf stable” refers to an animal consumable product, which is commercially processed and can be safely stored at room temperature in a sealed container. This includes animal consumable products, which have been processed so that they can be safely stored at room or ambient temperature for a useful shelf life. In the context of this invention, the animal consumable product is considered shelf stable if it can last without degradation, oxidation, or spoilage (a) about 3 months or longer if stored at ambient temperature, or (b) about 4 months or longer if stored under refrigerated conditions.

A “flavorant” is a chemical compound or combination of compounds, which imparts a desired taste to a composition to which the flavorant is added. A flavorant can include any one or more volatile compounds, which may form a part of an ingredient in the formula.

An “aromant” is a chemical compound or combination of compounds that imparts a desired scent or “aroma” to a composition to which the aromant is added. An aromant can include any one or more volatile compounds, which may form a part of an ingredient in the formula.

The term “volatile compound” (singular or plural) generally refers to a volatile chemical that evaporates easily and contributes significantly to a food's aroma and flavor and that plays a crucial role in olfactory and gustatory sensory perception.

The term “pyrazine” (singular or plural) generally refers to a group of heterocyclic, nitrogen-containing, volatile compounds contributing roasted and nutty aromas and flavors in food products. Pyrazines are key contributors to the characteristic roasted and nutty aroma of peanut butter. See Baker, G. L. & Cornell, J. A. & Gorbet, D. W. & O'Keefe, Sean & Sims, C. A. & Talcott, Stephen. (2006). Determination of Pyrazine and Flavor Variations in Peanut Genotypes During Roasting. Journal of Food Science. 68. 394-400. 10.1111/j. 1365-2621.2003.tb14171.x.

The term “ethylpyrazine”, also known as 2-ethylpyrazine, generally refers to a volatile compound that is member of the pyrazine family, found in roasted foods like coffee, nuts including peanuts and bread, and are known to provide a musty, nutty, and peanut-like odor and flavor.

The term “methylpyrazine”, also known as 2-methylpyrazine, refers to a naturally occurring, volatile compound with a nutty, chocolate, and green odor, found in foods like coffee, peanuts, and red peppers.

The term “maltol” refers to a naturally occurring, volatile compound and a flavor enhancer, known for its caramel and cotton candy-like aroma. See Flavor Bites: Maltol. https://www.perfumerflavorist.com/flavor/ingredients/article/21857319/flavor-bites-maltol (accessed 2025 Jan. 27).

The term “4-methylthiazole” generally refers to a volatile compound having a thiazole derivative, known for its green, nutty, and roasted meat-like odor. See 4-methyl thiazole, 693-95-8. https://www.thegoodscentscompany.com/data/rw1037611.html #toorgano (accessed 2025 Jan. 27).

The term “acetoin”, also known as 3-hydroxy-2-butanone, refers to a volatile compound used in food products, known for its sweet, buttery, and creamy taste. See Acetoin, 513-86-0. https://www.thegoodscentscompany.com/data/rw1007331.html #toorgano (accessed 2025 Jan. 27).

The term “p-cresol”, also known as 4-methylphenol, refers to a volatile compound, known for providing an aroma compound in cheese, bacon, smoked foods. See Para-cresol, 106-44-5. https://www.thegoodscentscompany.com/data/rw1003851.html #toorgano (accessed 2025 Jan. 27).

The term “eucalyptol”, also known as 1,8-cineole, refers to a volatile compound found in essential oils of plants like eucalyptus, rosemary, and camphor laurel, known for a camphor-like odor and a spicy, cooling flavor. See Clark, G; Easton, C; Easton, S. Eucalyptol. Perfumer & Flavorist. 2000, vol. 25, May/June.

The term “pyridine” refers to a volatile compound known for a sour odor.

### Pet Treat

Described herein is a chewable animal consumable, i.e., pet treat, intended to be provided to animals for purposes, including nutrition, administration of beneficial agents to the animal, and general enjoyment by the animal. The pet treat described herein is intended to be consumed by companion animals or pets such as dogs or cats and provided to companion animals by their caregivers. The pet treats are believed to represent advances over previously known pet treats in several respects.

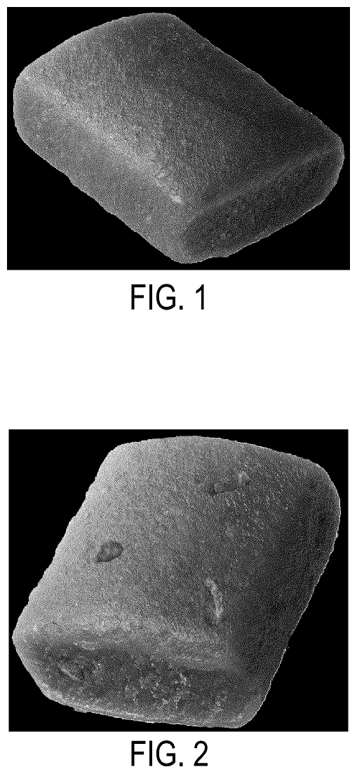

Broadly speaking, and referring generally to FIGS. 1-2, the pet treats described herein are formed of a chewable matrix in a shape and dimensions selected to (i) fit within the oral cavity of an animal such as a dog, and (ii) to facilitate chewing and consumption of an individual pet treat by an animal. The composition of the texture matrix includes one or more ingredients that renders it appetizing to the animal, i.e., a flavorant or aromant that tends to induce the animal to cat it. The matrix includes structural ingredients that confer a malleable texture to the matrix of the pet treat, such that the pet treat is chewable, but not crumbly. The pet treat can have optional inclusions.

An important characteristic of the pet treat described herein is that they can be readily manufactured with certain organoleptic characteristics. Such organoleptic characteristics can be selected to appeal to one or both of an animal and a human that cares for the animal. By way of example, pet treats can have texture, flavor, and aroma characteristics, which pets find appealing, while having characteristics, which pet owners find appealing, such as non-sticky and low surface oil residue.

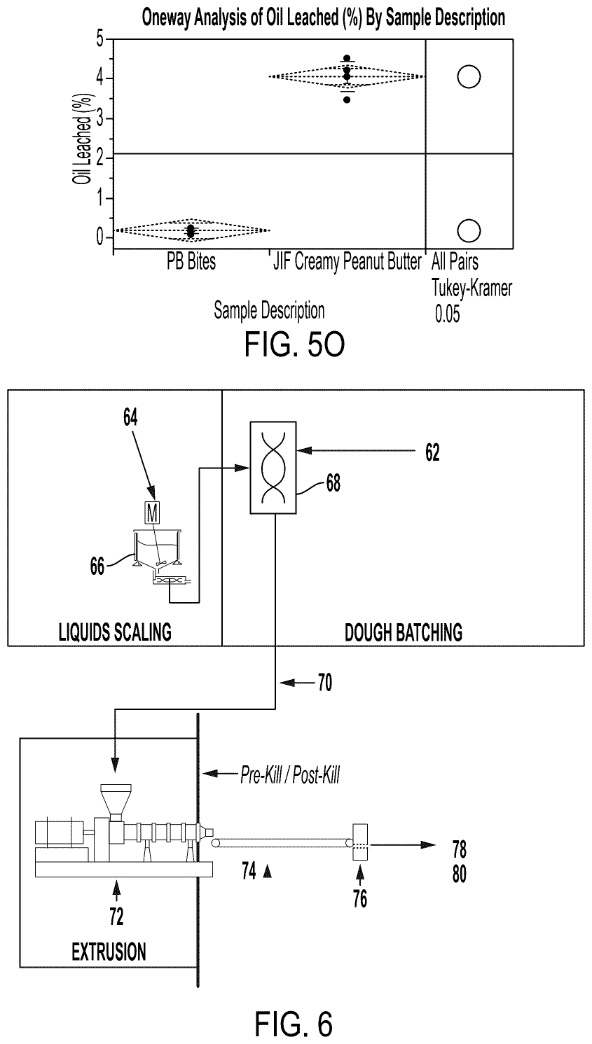

The pet treat of the invention can be made from formulas for the compositions of Tables 1-5. The formulas are used to produce homogeneous, malleable (non-crumbly) compositions to form the pet treat. The pet treat is produced by a manufacturing process illustrated in FIG. 6.

The composition of the pet treat can include at least one cereal grain. The cereal grain can be, for example, wheat or whole wheat. The cereal grain can be ground, i.e., flour. The cereal grain provides starch, protein, moisture, vitamins, and minerals, which contribute to the characteristics of the matrix of the pet treat. In a non-limiting example, wheat flour is used. Wheat flour can be milled from a blend of hard wheat and can be a high gluten flour. Wheat flour can be an enriched flour having Niacin, reduced Iron, Thiamine Mononitrate, Riboflavin, and Folic Acid. The native starch component of the wheat flour, like other cercal grain starches, consists primarily of amylopectin with lower amounts of amylose, averaging about 25% by weight (range of about 20-30% by weight). The starch of wheat flour has a porous, granular structure capable of absorbing or binding oil and water. This characteristic contributes to the malleability of, and oil retention within, the matrix.

In non-limiting, exemplary embodiments, the pet treat includes wheat flour at a range of about 10-30 wt % of the formula for the composition used to form the pet treat. This range includes subranges of about 15-30 wt %, about 10-13 wt %, 17.5-27.5 wt %, 20-25 wt %, and about 22-30 wt % of the formulation for the pet treat, depending on the unique combination of ingredients of the formulation.

The composition of the pet treat can include pregelatinized wheat flour. Pregelatinized wheat flour is a highly digestible starch derived from wheat flour, which has been pre-cooked, dried, and ground into powder form. Pregelatinized wheat flour is water soluble and can absorb and retain moisture as an ingredient in processed food. Pregelatinized wheat flour is a binder and stabilizer for food products and contributes to texture and shelf-life. Pregelatinized wheat flour provides modified starch, which, from gelatinization, has an enhanced porous, granular structure capable of absorbing or binding oil. This characteristic contributes to the malleability of, and oil retention within, the matrix.

In non-limiting, exemplary embodiments, the pet treat includes pregelatinized wheat flour at a range of about 5-15 wt % of the formula for the pet treat, depending on the unique combination of ingredients of the formulation.

The composition of the pet treat can include peanut flour. Peanut flour contains protein, fat, starch, fiber, vitamins, and minerals. The peanut flour can be partially defatted (i.e., about 12-28% fat) and made from high oleic raw peanuts. The peanut flour is gluten-free. High oleic peanuts are more stable than traditional peanuts and provide a more stable peanut flour. Peanut flour, along with peanut butter, contributes volatile compounds to the pet treat, which provide a distinct aroma.

In non-limiting, exemplary embodiments, the pet treat can include peanut flour in a range of about 0-25 wt % of the formula for the composition used to form the pet treat. This range includes subranges of about 6-10 wt % and 4-9 wt % of the formula for the pet treat, depending on the unique combination of ingredients of the formulation.

The composition of the pet treat can include a liquid sweetener. Liquid sweetener contains sucrose, glucose, fructose, and/or maltose, along with water. A liquid sweetener is generally hydrophilic and competes for water and can reduce moisture-based oil migration. In non-limiting embodiments, the liquid sweetener can be any one or combination of agave nectar, rice syrup, brown rice syrup, honey, maple syrup, coconut syrup, date syrup, barley malt syrup, tapioca syrup, cane syrup, simple syrup, or molasses.

In non-limiting, exemplary embodiments, the pet treat can include at least one liquid sweetener at a range of about 2-25 wt % of the formula for the composition used to form the pet treat. This range includes subranges of about 2-11 wt %, about 4-8 wt % and about 20-25 wt % of the formula for the pet treat, depending on the unique combination of ingredients of the formulation.

The composition of the pet treat can include peanut butter. Peanut butter provides a relatively high amount of unsaturated, mostly monounsaturated (oleic acid) and some polyunsaturated (linoleic acid) fats, as well as protein and carbohydrates. Some peanut butter can have added oil, like palm oil, to maintain consistency or prevent oil separation. Peanut butter includes natural oil from the ground peanuts used to make peanut butter. This oil can naturally separate from peanut butter in the absence of stabilizers, like natural peanut butter, or the oil can be emulsified with hydrogenated oils in peanut butter to prevent separation, like stabilized peanut butter, but remains present, nonetheless. In non-limiting embodiments, the peanut butter can be natural peanut butter, a stabilized natural peanut butter, or a smooth peanut butter comprising dry roasted peanuts, dextrose, a high melting point fat stabilizer, and salt. Peanut butter, along with peanut flour, contributes volatile compounds to the pet treat, which provides a distinct peanut aroma.

In non-limiting, exemplary embodiments, the pet treat can include peanut butter in a range of about 9-20 wt % of the formula for the composition used to form the pet treat. This range includes subranges of about 9-18 wt %, about 11-16 wt %, about 12.5-16.5 wt %, and about 17-20 wt %, of the formula for the pet treat, depending on the unique combination of ingredients of the formulation.

The composition of the pet treat can optionally have inclusions. Inclusions can be pieces of meat selected for being appetizing by the target animal, such as, for example, chicken, beef, or pork, or related by-products for consumables intended for dogs. In a non-limiting embodiment, the meat can be bacon. The bacon can be pieces trimmed from the slicing and packaging of cured pork bellies. The bacon can be ground with a ¼ inch plate or smaller. Alternatively, inclusions can be pieces of nuts, fruit, cereal grains, or other elements. For example, the inclusions can be textured vegetative protein (TVP). TVP provides complete soy protein with all the amino acids essential to human nutrition and is a good source of dietary fiber, iron, magnesium, and phosphorus. Cereal grain inclusions can be, for example, rolled oats or pieces of rolled oats. The rolled oats can be included up to about 5 wt % of the formula for the composition used to form the pet treat.

The composition of the pet treat can include at least one acid or preservative. Acids and preservatives can be selected for the purpose of inhibiting microbial growth or spoilage of packaged pet treats during storage. Such acid(s) or preservative(s) can contribute to extending the shelf life of the pet treat after it is packaged. In an exemplary embodiment, the pet treat can include any one or more of the following acids or preservatives: (1) potassium sorbate, (2) citric acid, (3) citric acid in a vinegar buffer (Previon VC dry), and/or (4) a liquid antioxidant (Naturox). In such non-limiting embodiments, the acid or preservative comprises about 0.5-2 wt % of the formula for the composition used to form the pet treat.

The composition of the pet treat can include water. Without being bound to any theory of operability, the water content contributes to the prevention of spoilage of the pet treat after it is packaged. In non-limiting, exemplary embodiments, the pet treat can include water at about 5-18 wt %, about 9-18 wt %, and about 15-18 wt % of the formula for the composition used to form the pet treat. The water, along with moisture of other ingredients, contributes to a total moisture content of the pet treat up to about 24 wt % of the formula for the composition used to form the pet treat. The pet treat has a water activity in a range of about 0.65 to about 0.73.

The composition of the pet treat can include at least one humectant. For example, the humectant can be one or more of glycerol, propylene glycol, or other known humectants. Such humectants can assist with shelf stability by binding water, thus reducing moisture to a level at which bacteria are unable to grow. The humectant(s) can also be combined with an antimycotic agent, such as potassium sorbate and/or citric acid, to inhibit the growth of yeasts and molds. In a non-limiting embodiment, the pet treat has a humectant in a range of about 15-26.5 wt % of the formula for the composition used to form the pet treat. This range includes subranges of about 18-26 wt %, about 17-19 wt %, and about 19-23 wt % of the formula for the composition used to form the pet treat, depending on the unique combination of ingredients of a formulation.

The composition of the pet treat can include an emulsifier and/or a stabilizer. Without being limited to any theory of operability, the emulsifier and/or the stabilizer contribute to reducing oil separation of the peanut butter within the matrix. In non-limiting, exemplary embodiments, the emulsifier and/or the stabilizer comprises about 0.2-2.0 wt % of the formula for the composition used to form the pet treat. Non-limiting examples of the emulsifier and/or the stabilizer include lecithin (e.g., sunflower or soy), mono-glycerides, diglycerides, polysorbates, carrageenan, guar gum, or any high melting point fat.

The composition of the pet treat may optionally include canola oil. Without being limited by any theory of operability, canola oil may contribute to the texture of the pet treat and may also be a processing aid in manufacturing. In a non-limiting embodiment, the pet treat has canola oil at about 1 wt % of the formula for the composition used to form the pet treat.

The composition of the pet treat may optionally include carnauba wax. Without being limited by any theory of operability, carnauba wax may enhance the texture of the pet treat and may also be a stabilizer for the pet treat. Carnauba wax may also increase the longevity and freshness of the pet treat. In a non-limiting embodiment, the pet treat has carnauba wax at about 0.2 wt % of the formula for the composition used to form the pet treat.

Any of a wide variety of agents known to be desirable in pet treat products can also be included in the composition of the pet treat. Examples of suitable additional ingredients include vitamins, minerals, acids, flavorants, aromants, and colorants. Vitamins, minerals, acids, flavorants, aromants, and colorants can be selected and formulated to be present in amounts that achieve recognized functionalities but also should be selected to be suitable for consumption by the animal. In a non-limiting example, a flavorant can be provided in a range of about 0-0.5 wt % of the pet treat. Hickory charsol can be used as a flavorant.

The pet treat can be made from various formulations to embody the desired organoleptic qualities, including a malleable texture with sufficient water retention, a surface with low adhesiveness, i.e., not sticky, a matrix capable of retaining or binding oil so that matrix has low amount of oil on its surface, and an appetizing peanut butter-like aroma. The formulas include components selected within ranges for providing the desired organoleptic qualities. A certain component or combinations of components contribute a significant role to achieving the desired organoleptic qualities with such contribution supported by other components used to form the matrix.

Without being limited to any theory of operability, the solubility and binding characteristics of pregelatinized wheat flour supports the viscosity of the dough used to form the pet treat. These characteristics of pregelatinized wheat flour also contribute to the texture of the matrix, providing organoleptic characteristics of the pet treat. The combination of the characteristics of pregelatinized wheat flour with liquid sweetener contributes to the malleable (non-crumbly) texture of the homogenous matrix of the pet treat. The proportions of pregelatinized wheat flour to liquid sweetener should be selected in amounts sufficient to confer a malleable (non-crumbly) characteristic of the texture matrix forming the homogenous composition of the pet treat.

Without being bound by any theory of operability, the combination of pregelatinized wheat flour with the liquid sweetener contributes to the oil retention or binding within the matrix, i.e., prevents oil separation or oiling out of the pet treat so the pet treat has low surface oil and oil transference. The proportions of pregelatinized wheat flour to liquid sweetener (in combination with other ingredients, for example, emulsifier and stabilizer) should be selected in amounts sufficient to confer oil retention properties to the texture matrix of the pet treat. Oil retention properties include the retention of oil within the texture matrix of the pet treat as the result of the oil being (i) absorbed or bound by stabilizing agents, e.g., starch of wheat flour or pregelatinized wheat flour, within the texture matrix, (ii) retained within the texture matrix as a result of sweeteners and/or humectants competing for moisture, (iii) emulsifiers stabilizing oil, or any combination thereof.

Without being bound to any theory of operability, the combination of pregelatinized wheat starch, wheat starch and humectant contributes to water retention within the matrix of the pet treat to support malleability. The interaction of humectant, wheat starch, and pregelatinized wheat starch contributes to the overall moisture retention in the composition of the pet treat up to about 24 percent by weight. In non-limiting embodiments, the formulas for the compositions formed into the pet treat have a ratio of humectant to wheat flour in a range of about 1.77:1 to about 0.5:1, about 1:0.7 to about 1:1.4; or about 1:0.7 to about 1:0.95. Additionally, the formulas for the compositions formed into the pet treat have a ratio of humectant to pregelatinized wheat flour in a range of about 0.5:1 to about 1.77:1, about 0.5:1 to about 2.4:1, about 0.5:1 to about 1.44:1, about 1:0.2 to about 1:0.7, or about 2.2:1 to about 2.4:1. Finally, the formulas for the compositions formed into the pet treat have a ratio of pregelatinized wheat flour to liquid sweetener in a range of about 1.5:1 to 5:1, about 2.5:1 to about 0.8:1, about 1.77:1 to about 0.5:1, about 1.6:1 to about 1.5:1, about 1:0.7 to about 1:1.4; or about 1:0.7-1:0.95.

Without being limited to any theory operability, the combination of peanut butter and peanut flour within the matrix contributes to the peanut butter-like aroma. The proportions of peanut butter and peanut flour (in combination with other ingredients, such as flavorants) should be selected in amounts sufficient to enhance volatile compounds related to a distinct peanut butter-like aroma in the texture matrix of the homogenous composition of the pet treat. The texture matrix may be enriched in one or more volatile compounds, including any one or more of the pyrazines in the sum of pyrazines (i.e., acetylpyrazine, methylpyrazine, ethylpyrazine, 2,3-dimethylpyrazine, 2,5-dimethylpyrazinc, 2,6-dimethylpyrazine, 2-ethyl-5-methylpyrazine, and 3-ethyl-2,5-dimehtylpyrazine), maltol, 4-methylthiazole, acetoin, p-cresol, cucalyptol, pyradine, and benzyl alcohol. In a non-limiting embodiment of the PB Bites pet treat and the PBB Bites pet treat, the texture matrix may be enriched in one or more pyrazines and/or maltol where the ratio of area content of pyrazines to maltol is greater than 200. In another non-limiting embodiment of the PB Bites and the PBB Bites, the texture matrix may be enriched in 4-methylthiazole and/or acetoin where the ratio of area content of 4-methylthiazole to acetoin is greater than 0.8.

Without being limited to any theory operability, the combination of the characteristics of peanut butter and peanut flour within the matrix can be enhanced with other inclusions, e.g., bacon, and flavorant, e.g., hickory charsol, which contribute a distinct aroma to the peanut butter-like aroma. For example, the texture matrix of PBB Bites pet treat may be enriched in p-cresol and/or eucalyptol where the ratio of area content of p-cresol to cucalyptol is greater than 20. In yet a further non-limiting embodiment of the PBB Bites pet treat, the texture matrix may be enriched in pyridine and/or benzyl alcohol where the ratio of area content of pyridine to benzyl alcohol is greater than 5.

Other components may also contribute to enhancing the organoleptic characteristics of the pet treat, including an emulsifier and/or a stabilizer for further reducing oil separation of the peanut butter, and carnauba wax to enhance the texture of the pet treat and to be a stabilizer.

In a non-limiting embodiment, a pet treat is provided and comprises a homogeneous, malleable (non-crumbly) composition made from a formula comprising pregelatinized wheat flour at about 5-15 wt % of the composition; wheat flour at about 15-30 wt % of the composition; liquid sweetener at about 2-11 wt % of the composition; peanut butter at about 9-18 wt % of the composition; peanut flour 4.5-12 wt % of the composition; water at about 13.5-18 wt % of the composition; and a humectant (e.g., glycerin) at about 15-26.5 wt % of the composition.

In another non-limiting embodiment, a pet treat is provided and comprises a homogeneous, malleable (non-crumbly) composition made from a formula comprising pregelatinized wheat flour at about 5-15 wt % of the composition; wheat flour at about 15-30 wt % of the composition; liquid sweetener at about 2-11 wt % of the composition; peanut butter at about 9-18 wt % of the composition; water at about 15-18 wt % of the composition; a humectant (e.g., glycerin) at about 15-26.5 wt % of the composition; an inclusion at about 3 wt % of the composition; another inclusion at about 3 wt % of the composition; and a flavorant at about 0.1 to about 0.3 wt % of the composition.

In a further non-limiting embodiment, a pet treat is provided and comprises a homogeneous, malleable (non-crumbly) composition made from a formula comprising wheat flour at about 10-15 wt % of the composition; liquid sweetener at about 20-25 wt % of the composition; peanut butter at about 17-20 wt % of the composition; peanut flour at about 0-25 wt % of the composition; a humectant (glycerin) at about 15-26.5 wt % of the composition, and an inclusion at about 3 wt % of the composition.

In a further non-limiting embodiment, a pet treat is provided and comprises a homogeneous, malleable (non-crumbly) composition made from a formula comprising wheat flour at about 22-30 wt % of the composition; liquid sweetener at about 20-25 wt % of the composition; peanut butter at about 17-20 wt % of the composition; a humectant (glycerin) at about 15-26.5 wt % of the composition, and an inclusion at about 3 wt % of the composition.

In a further non-limiting embodiment, a pet treat is provided and comprises a homogeneous, malleable (non-crumbly) composition made from a formula comprising wheat flour at about 22-30 wt % of the composition; liquid sweetener at about 22-25 wt % of the composition; peanut butter at about 17-20 wt % of the composition; peanut flour at about 6-10 wt % of the composition; a humectant (glycerin) at about 15-26.5 wt % of the composition, and an inclusion at about 3 wt % of the composition.

### EXAMPLES

The subject matter of this disclosure is described now with reference to the following Examples set forth below in Tables 1 through 5. These Examples are provided for the purpose of illustration only, and the subject matter is not limited to these Examples but rather encompasses all variations which are evident from the teaching provided herein.

### Example 1

Table 1 lists illustrative recipe ranges for some embodiments of the pet treat without inclusions described herein. Also listed are more specific formulas for a particular embodiment, designated “Formula 1” and “Formula 2”. Components are listed as percentage by weight of the dough, prior to extrusion, rather than by weight percentage in the matrix formed from the dough by extrusion and passage through a die. Note that the amount of water, including humectants and other components, can be greater than the final water content of the matrix of the pet treat, owing to water loss from the composition during dough formation and subsequent extrusion and controlled cooling of the formed pet treat.

TABLE 1
Pet Treat Formula

| | General | | |
|---|---|---|---|
| | Proportions | Formula 1 | Formula 2 |
| Ingredient | (wt. %) | (wt. %) | (wt. %) |
| Wheat Flour | 15-30 | 17.5-27.5 | 20-26 |
| Pre-Gelatinized Wheat Flour | 5-15 | 5-15 | 7-12 |
| Partially Defatted Peanut Flour | 0-25 | 5-20 | 4-10 |
| Liquid Sweetener | 2-11 | 3.5-8.5 | 4-7 |
| Peanut Butter | 9-18 | 12.5-16.5 | 11-15 |
| Humectant (Glycerin) | 15-26.5 | 18-26 | 19-23 |
| Water | 4-18 | 12.5-18 | 14-17 |
| Potassium Sorbate | <1 | <1 | <1 |
| Citric Acid | ≤1 | ≤1 | ≤1 |
| Antioxidant (Naturox) | <1 | <1 | <1 |
| Calcium Carbonate | <1 | <1 | <1 |
| TOTAL | 100 | 100 | 100 |

Table 2 lists illustrative recipe ranges for some embodiments of the pet treat having inclusions described herein. Also listed are more specific formulas for a particular embodiment, designated “Formula 3” and “Formula 4”. Like Example 1, components are listed as percentage by weight of the dough, prior to extrusion, rather than by weight percentage in the matrix formed

### Example 2

from the dough by extrusion and passage through a die. Note that the amount of water, including humectants and other components, can be greater than the final water content of the matrix of the pet treat, owing to water loss from the composition during dough formation and subsequent extrusion and controlled cooling of the formed pet treat.

TABLE 2
Pet Treat Formula with Inclusions

| | General | | |
|---|---|---|---|
| | Proportions | Formula 3 | Formula 4 |
| Ingredient | (wt. %) | (wt. %) | (wt. %) |
| Wheat Flour | 15-30 | 17.5-27.5 | 20-23.5 |
| Pre-Gelatinized Wheat Flour | 5-15 | 5-15 | 7.5-10 |
| Partially Defatted Peanut Flour | 0-25 | 5-20 | 5-16 |
| Textured Vegetable Protein (TVP) | 2-4 | 3 | 3 |
| Frozen Bacon | 2-4 | 3 | 3 |
| Hickory Charsol | <1 | 0.1-0.5 | 0.1-0.5 |
| Liquid Sweetener | 2-11 | 4-8 | 4-7 |
| Peanut Butter | 9-18 | 12.5-16.5 | 12.5-15 |
| Humectant (Glycerin) | 15-26.5 | 18-26 | 20-23 |
| Water | 4-18 | 10-18 | 12-18 |
| Potassium Sorbate | <1 | <1 | <1 |
| Citric Acid | ≤1 | ≤1 | ≤1 |
| Antioxidant (Naturox) | <1 | <1 | <1 |
| Calcium Carbonate | <1 | <1 | <1 |
| TOTAL | 100 | 100 | 100 |

### Example 3

Table 3 lists illustrative recipe ranges for some embodiments of the pet treat having inclusions described herein. Also listed are more specific formulas for a particular embodiment, designated “Formula 5”. Like in prior Examples, components are listed as percentage by weight of the dough, prior to extrusion, rather than by weight percentage in the matrix formed from the dough by extrusion and passage through a die. Note that the amount of water, including humectants and other components, can be greater than the final water content of the matrix of the pet treat, owing to water loss from the composition during dough formation and subsequent extrusion and controlled cooling of the formed pet treat.

TABLE 3
Pet Treat Formula

| | General | |
|---|---|---|
| | Proportions | Formula 5 |
| Ingredient | (wt. %) | (wt. %) |
| Partially Defatted Peanut Flour | 0-25 | 5-20 |
| Liquid Sweetener | 20-25 | 20-25 |
| Peanut Butter | 17-20 | 17-20 |
| Humectant (Glycerin) | 15-26.5 | 17-19 |
| Whole Wheat Flour | 0-15 | 0-15 |
| Rolled Oats | 2-5 | 3 |
| Potassium Sorbate | <1 | <1 |
| Antioxidant (Naturox) | <1 | <1 |
| Carnauba Wax | <1 | <1 |
| Emulsifier / Stabilizer (Lecithin) | <1 | <1 |
| TOTAL | 100 | 100 |

### Example 4

Table 4 lists illustrative recipe ranges for some embodiments of the pet treat having inclusions described herein. Also listed are more specific formulas for a particular embodiment, designated “Formula 6”. Like in prior Examples, components are listed as percentage by weight of the dough, prior to extrusion, rather than by weight percentage in the matrix formed from the dough by extrusion and passage through a die. Note that the amount of water, including humectants and other components, can be greater than the final water content of the matrix of the pet treat, owing to water loss from the composition during dough formation and subsequent extrusion and controlled cooling of the formed pet treat.

TABLE 4
Pet Treat Formula

| | General Proportions | Formula 6 |
|---|---|---|
| Ingredient | (wt. %) | (wt. %) |
| Whole Wheat Flour | 10-30 | 22-30 |
| Liquid Sweetener | 20-25 | 20-25 |
| Peanut Butter | 17-20 | 17-20 |
| Humectant (Glycerin) | 15-26.5 | 17-19 |
| Water | 4-18 | 4-18 |
| Canola Oil | 1-3 | 1-3 |
| Rolled Oats | 2-4 | 3 |
| Previon VC Dry | <1 | <1 |
| Antioxidant (Naturox) | <1 | <1 |
| Carnauba Wax | <1 | <1 |
| Emulsifier / Stabilizer (Lecithin) | <1 | <1 |
| TOTAL | 100.00 | 100 |

### Example 5

Table 5 lists illustrative recipe ranges for some embodiments of the pet treat having inclusions described herein. Also listed are more specific formulas for a particular embodiment, designated “Formula 7”. Like in prior Examples, components are listed as percentage by weight of the dough, prior to extrusion, rather than by weight percentage in the matrix formed from the dough by extrusion and passage through a die. Note that the amount of water, including humectants and other components, can be greater than the final water content of the matrix of the pet treat, owing to water loss from the composition during dough formation and subsequent extrusion and controlled cooling of the formed pet treat.

TABLE 5
Pet Treat Formula

| | General Proportions | Formula 7 |
|---|---|---|
| Ingredient | (wt. %) | (wt. %) |
| Whole Wheat Flour | 22-30 | 22-30 |
| Liquid Sweetener | 20-25 | 22-25 |
| Peanut Butter | 17-20 | 17-20 |
| Humectant (Glycerin) | 17-19 | 17-19 |
| Partially Defatted Peanut Flour | 6.5-10.5 | 6.5-10.5 |
| Water | 10-18 | 10-18 |
| Rolled Oats | 3 | 3 |
| Canola Oil | 1-3 | 1-3 |
| Antioxidant (Naturox) | <1 | <1 |
| Carnauba Wax | <1 | <1 |
| Emulsifier / Stabilizer (Lecithin) | <1 | <1 |
| TOTAL | 100 | 100 |

### Texture Analysis

A Texture Analyzer was used to test various texture properties including hardness, stickiness, and crumbliness of the pet treat, i.e., PB Bite, and other pet products on the market incorporating peanut butter or peanut butter flavor as an ingredient.

For this disclosure, texture analysis measurements show the resistance of a test sample to a compressive force, simulating the texture experienced by a pet while biting into the test sample. The test used a cylindrical shape “texture analysis fixture” as a testing probe to apply the compression force to the surface of a test sample. The texture analysis fixture was a 1.5 inch diameter rounded tip cylindrical shape testing probe TA-23 for the TA.XTplus Texture Analyzer (Stable Micro Systems, Ltd, Godalming, Surrey, U.K.). The texture analysis fixture was mounted on a Texture Analyzer (TA.XTplus Texture Analyzer) with a load cell of 50 kg, and a test sample was positioned in the texture analyzer's sample platform. During the measurement, the texture analysis fixture was pressed into the test sample for a controlled distance (70% strain height) at a controlled rate (1 mm/sec) and pulled off from the test sample after penetrating the defined distance. The forces exerted by the texture analysis fixture while (i) penetrating the test sample and (ii) pulling off from the test sample were measured. The test data was plotted as applied force (g) versus time (seconds) curve. From this curve, various texture properties were determined, including peak force, i.e., hardness, adhesiveness, i.e., stickiness, and crumbliness.

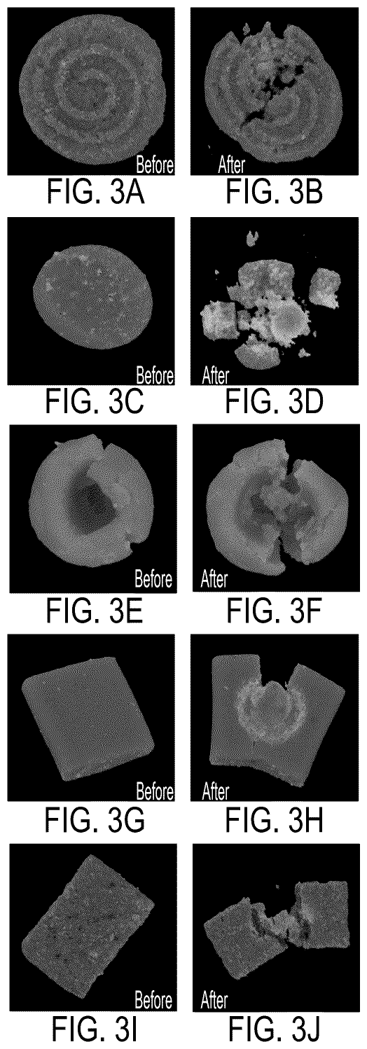

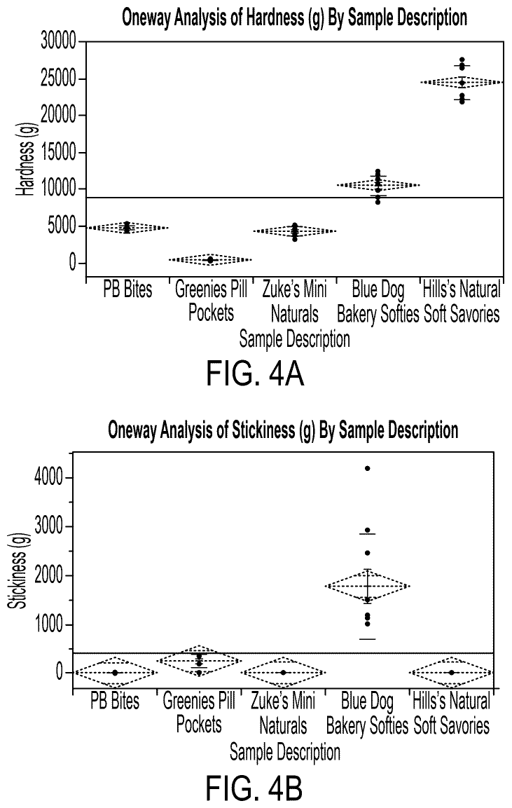

Referring to FIGS. 3A through 3J, qualitative texture testing was conducted between the pet treat, i.e., PB Bite, and other peanut butter treats in the market, i.e., Hill's Natural Soft Savories, Zuke's Mini Naturals, Greenies Pill Pockets, and Blue Dog Bakery Softies. The crumbliness and malleability of the test samples were measured qualitatively, i.e., by visual inspection of the state of each test sample after running the texture tests. The texture testing results show that the PB Bite of the invention exhibited a soft, malleable texture (supported by lower texture-hardness value of Table 6 and FIG. 4A) and did not crumble, shatter or break apart during the texture test, see, e.g., FIG. 3H. After force was applied, the other peanut butter treats in the market, i.e., Hill's Natural Soft Savories, Zuke's Mini Naturals, Greenies Pill Pockets, and Blue Dog Bakery Softies, showed separation of pieces, e.g., crumbling, of the composition, see, e.g., FIGS. 3B, 3D, 3F, 3J. Before and after photographs were taken of each pet treat tested during texture analysis. The PB Bites exhibited malleable characteristics by remaining in a single homogenous piece.

Referring to FIG. 4A, the composition provides the pet treat with a soft and malleable texture. Comparative peak force (hardness) testing showed that the pet treat (i.e., PB Bites) exhibited hardness measurably distinct from other pet treats tested. The peak force was the maximum positive force (g) applied to a test sample during the test and represented the overall hardness of the test sample. Peak force was measured when the measurement probe, i.e., the texture analysis fixture, reached maximum penetration after travelling the predefined distance. For most of the test samples, the peak force occurred at the end of the test, when the texture analysis fixture reached the maximum penetration depth into the sample (% strain height).

Ten (10) of each test sample were run with test result data shown on Table 6 and plotted in FIG. 4A, which shows oneway analysis of hardness gram (g) by sample. The test samples were the PB Bite of the invention, Hill's Natural Soft Savories (Hill's Pet Nutrition), Zuke's Mini Naturals (Zuke's Performance Pet Nutrition), Greenies Pill Pockets (Mars Petcare), and Blue Dog Bakery Softies (Blue Dog Bakery). A direct relationship exists between peak force and hardness, e.g., the higher the peak force measurement, the harder the test sample, and conversely, the lower the peak force measurement, the softer the sample.

TABLE 6
Oneway Analysis of Peak Force (Hardness)

| | No. of | Mean | Std. |
|---|---|---|---|
| Level | Samples | (g) | Dev. |
| PB Bites | 10 | 0.6386488 | 0.6827934 |
| Greenie's Pill Pockets | 10 | 245.66591 | 143.95199 |
| Zuke's Mini Naturals | 10 | 4.0191186 | 1.2427406 |
| Blue Dog Bakery Softies | 10 | 1769.7048 | 1077.6032 |
| Hill's Nature Soft Savories | 10 | 4.2255058 | 1.6619954 |

Referring to FIG. 4B, adhesiveness, i.e., stickiness, was measured as the maximum negative peak force (g) experienced by the texture analysis fixture while pulling the fixture away from each test sample after completing the peak force (hardness test). The PB Bite of the invention is not very adhesive, i.e., sticky (as supported by lower texture-stickiness value of Table 7 and FIG. 4B), as compared to pet treats in the market.

Texture testing showed a direct relationship between negative force and adhesiveness, i.e., the higher the maximum negative force measurement, the higher the stickiness of the test sample, and conversely, the lower the negative peak force measurement, the lesser the stickiness of the test sample. Ten (10) of each test sample were run with test data shown on Table 7 and plotted in FIG. 4B, which shows oneway analysis of stickiness (neg. g) by sample. Comparative adhesiveness testing (i.e., stickiness) was performed and showed that the PB Bite of the invention exhibited a statistically significant less adhesiveness, i.e., stickiness, as compared to the other pet treats tested including the Hill's Natural Soft Savories, Zuke's Mini Naturals, Greenies Pill Pockets, and Blue Dog Bakery Softies.

TABLE 7
Oneway Analysis of Stickiness

| | Sample | Mean | Std. |
|---|---|---|---|
| Level | Number | (neg. g) | Dev. |
| PB Bites | 10 | 4655.7579 | 255.39015 |
| Greenie's Pill Pockets | 10 | 345.26402 | 48.536171 |
| Zuke's Mini Naturals | 10 | 4229.0361 | 630.56681 |
| Blue Dog Bakery Softies | 10 | 10475.768 | 1324.8911 |
| Hill's Nature Soft Savories | 10 | 24438.805 | 2253.599 |

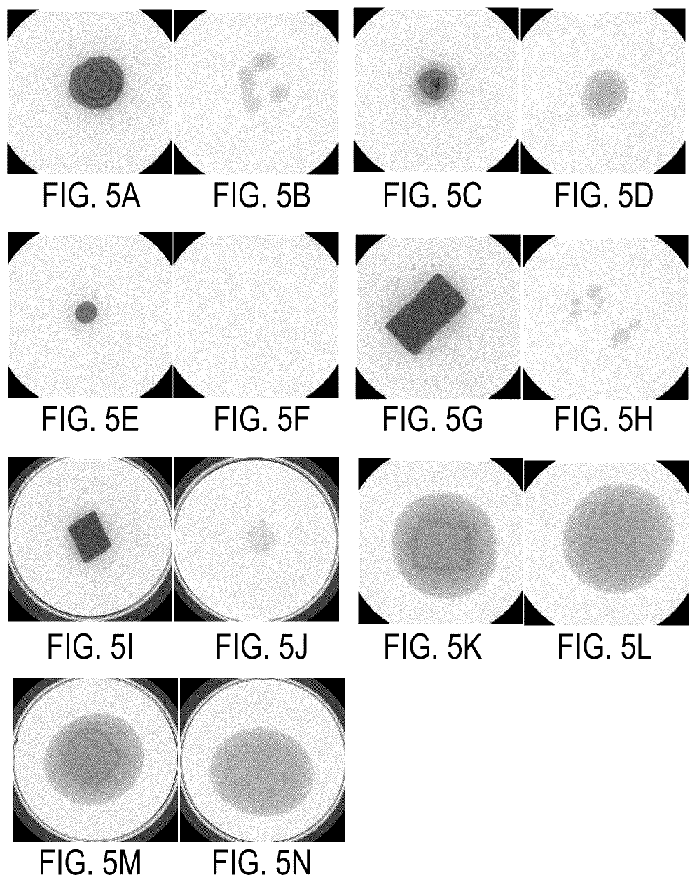

Referring to FIGS. 5A through 5N, comparative absorption testing was performed and qualitatively assessed. Qualitative absorption testing consisted of placing: (1) the PB Bite of the invention, (2) the other pet treats tested including the Hill's Natural Soft Savories, Zuke's Mini Naturals, Greenies Pill Pockets, and Blue Dog Bakery Softies, and (3) peanut butter cakes made from Jif Creamy Peanut Butter and Jimbo's Jumbo Peanut Butter (previously frozen into cakes), on filter paper, and, then, heating in an moisture oven for 30 minutes at about 110 degrees Fahrenheit. Videometer Multispectral Imaging System was used to capture images of the products on the filter paper and then the filter paper alone (after 30 minutes of heat exposure with the products) to evaluate oil absorption by the filter paper.

Referring to FIGS. 51, 5J, the composition used to form the PB Bite of the invention substantially retained oil of the peanut butter and provided the pet tret with low surface oil residue and oil transference to a surface to which the pet treat contacted. Of all test samples, the PB Bite exhibited the least amount of oil absorption by filter paper. The cakes of peanut butter exhibited the highest amount of oil absorption by filter paper. Hill's Natural Soft Savories, Greenies Pill Pockets, and Blue Dog Bakery Softies exhibited oil absorption by the filter paper somewhere between the peanut butter cakes and the PB Bite of the invention, while the Zuke's Mini Naturals showed some oil absorption by the filter paper.

Referring now to FIG. 5O, absorption testing was also performed and quantitatively assessed. The amount of oil transferred from each test sample was determined as a percentage of the weight of the test sample. Measurements of transferred oil and the weight of a test sample were initially obtained. The tare weight of a piece of filter paper (Whatman 41 Filter Paper) placed on a glass Petri dish (and covered with a lid) was measured. A test sample, i.e., PB Bite (FIGS. 51, 5J) or a previously frozen JIF Creamy Peanut Butter cake (FIG. 5M), placed on a piece of filter paper in the Petri dish and covered with a lid was weighed. The covered Petri dish with a test sample was placed in a moisture oven set at 100 degrees Fahrenheit for 30 minutes. After 30 minutes, the Petri dish with the test sample was removed from the oven and set aside to cool at ambient air temperature. The lid was uncovered, and the test sample was removed from the filter paper. The Petri dish with the filter paper was covered with the lid and weighed. The percentage of oil transferred from a test sample was calculated as: % Oil Content=(Oil Content*100)/Sample Weight. For example, if the oil content transferred to a piece of filter paper weighed 0.233 grams and the test sample weighed 44 g, then the percent (%) oil content is equal to ((0.233*100)/44) or 0.529% of the weight of test sample. Five (5) test samples of PB Bite (FIG. 51) or a previously frozen JIF Creamy Peanut Butter cake (FIG. 5M) were analyzed, and the test result data is shown in Table 8 and plotted in FIG. 5O. The test data shows that the PB Bites transfers significantly less oil as compared to peanut butter.

TABLE 8
Oneway Analysis of Oil Leached (%)

| Level | Sample Number | Mean (%) | Std. Dev. |
|---|---|---|---|
| PB Bites | 5 | 0.179322 | 0.0707537 |
| JIF Creaming Peanut Butter | 5 | 4.0527766 | 0.3776013 |
| (initially frozen) | | | |

### Aroma

Chemical analysis of the volatile organic compounds, i.e., aroma analysis, was performed on PB Bite of the invention and the PBB Bite with bacon inclusions of the invention, along with four pet treats on the market (with each pet product incorporating peanut butter or peanut butter flavor as an ingredient), including Beggin' Strips with bacon and peanut flavor (Nestlé Purina PetCare, C1), Blue Dog Bakery Softies with peanut butter flavor (Blue Dog Bakery, C2), Bocce's Soft & Chewy peanut butter and banana (Bocce's Bakery, C3), and Zuke's Mini Naturals with peanut butter and oats (Zuke's Performance Pet Nutrition, C4). Aroma analysis was conducted using Solid phase microextraction (SPME) followed by analysis using gas chromatography mass spectrometry (GCMS). GCMS uses the volatility of compounds and their interactions with polar and non-polar phases for separation. Compounds are then detected and identified by their molecular weight and unique fragmentation patterns with the mass spectrometer.

The aroma profile of ten (10) dry pet food samples was analyzed by Headspace-Solid Phase Microextraction (HS-SPME) and Gas Chromatography-Mass Spectrometry (GC/MS). Test samples were ground, and 2.0 grams of ground test samples were placed in a 20 mL headspace vial (Gerstel, Mülheim an der Ruhr, Germany) equipped with a polytetrafluoroethylene/silicone septum (Gerstel, Mülheim an der Ruhr, Germany). An internal standard was added to each vial (2-methyl-3-heptanone, 50 μL, 10 mg/L in ethanol). An injector was equipped with an automated MultiPurpose Sampler (Gerstel, Linthicum, MD, USA) with 2 cm SPME fiber (50/30 μm DVB/CAR/PDMS, Supelco Analytical, Bellefonte, PA, USA). The SPME fiber was preconditioned at 250 degrees Celsius for 30 min before initial use. Samples were placed in an incubator at 45 degrees Celsius for 5 min and agitated for 10 seconds at 250 rpm. The SPME fiber was inserted into the vials (31 mm vial penetration, 43 mm injection penetration) with a 10-minute extraction time. The volatile compounds were desorbed from the SPME fiber for 300 seconds and introduced onto the GC column in splitless mode. The SPME fiber was inserted into the front inlet (10 minutes, 250 degrees Celsius, penetration 43 mm) to bake out between samples.

Tentative identification and relative abundance of the volatile compounds were performed on an Agilent 7890B GC (Agilent Technologies, Santa Clara, CA, USA) equipped with a DB-Wax column (60 m×0.250 mm×0.25 μm, Agilent Technologies, Santa Clara, CA, USA) and coupled with an Agilent 7250A QTOF Mass Spectrometer (Agilent Technologies, Santa Clara, CA, USA). The initial temperature of the oven was set at 40 degrees Celsius and held for 1 minute, then the temperature increased by 6 degrees Celsius per minute to 220 degrees Celsius and held at this temperature for 10 minutes. All samples were analyzed in triplicate. To identify the compounds, a minimum match factor (>75%) and peak shape quality (>75%) were required to be considered as a library match via the NIST23 library (NIST/EPA/NIH Mass Spectral Library, 2023, Gaithersburg, MD, USA).

Multivariate statistics indicated a clear differentiation of volatile compounds across samples tested, primarily in two groups.

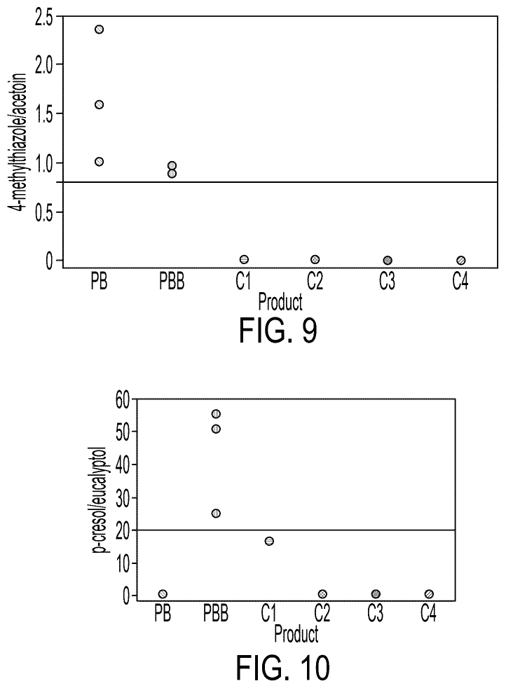

The PB Bite and the PBB Bite with bacon inclusions of the invention each showed an abundance ratio (as area content) of the sum of pyrazine to maltol, see, FIG. 8, and of 4-methylthiazole to acetoin, see, FIG. 9, in comparison to pet treats in the market, C1, C2, C3, C4.

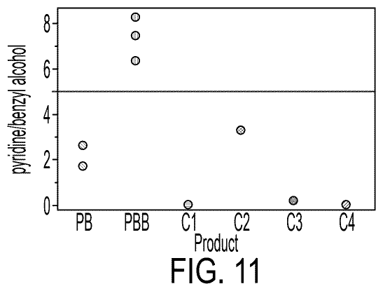

Aroma analysis also showed that the PBB Bite with bacon inclusions of the invention had an abundance ratio (as area content) of p-cresol to cucalyptol, see, FIG. 10, and of pyridine to benzyl alcohol, see FIG. 11, in comparison to the four (4) pet treats in the market, including Beggin' Strips with bacon and peanut flavor (Nestlé Purina PetCare, C1), Blue Dog Bakery Softies with peanut butter flavor (Blue Dog Bakery, C2), Bocce's Soft & Chewy peanut butter and banana (Bocce's Bakery, C3), and Zuke's Mini Naturals with peanut butter and oats (Zuke's Performance Pet Nutrition, C4).

Aroma analysis shows that the PB Bite and PBB Bite with bacon inclusions of the invention were enriched in certain volatile organic compounds in comparison to four pet treats on the market, including Beggin' Strips with bacon and peanut flavor (Nestlé Purina PetCare, C1), Blue Dog Bakery Softies with peanut butter flavor (Blue Dog Bakery, C2), Bocce's Soft & Chewy peanut butter and banana (Bocce's Bakery, C3), and Zuke's Mini Naturals with peanut butter and oats (Zuke's Performance Pet Nutrition, C4).

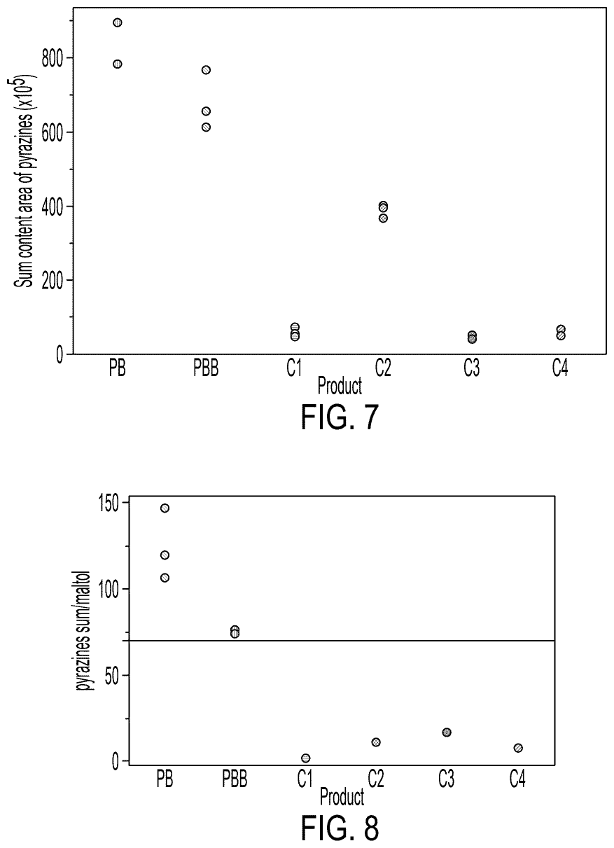

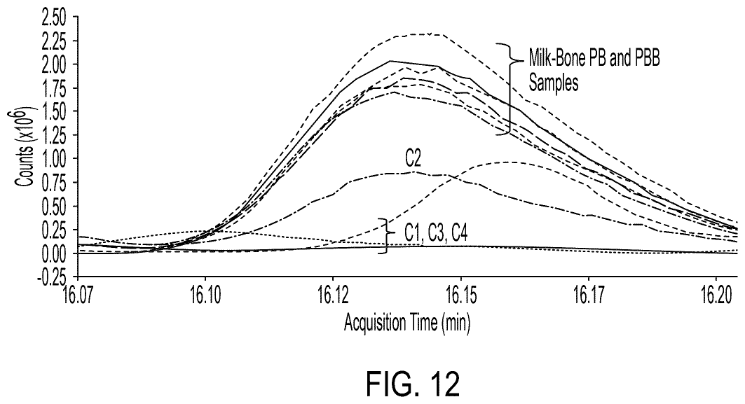

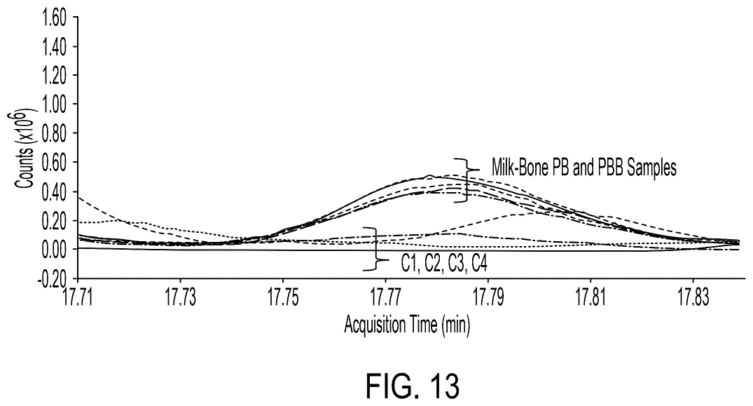

The aroma of the PB Bite and PBB Bite with bacon inclusions of the invention was defined by the area content ratio of (i) the sum of pyrazines: maltol and (ii) the area content ratio of 4-methylthiazole: acetoin. Aroma analysis shows that the PB Bite and PBB Bite with bacon inclusions were enriched in pyrazines, see FIG. 7. Summing the area content of pyrazines (i.e., acetylpyrazine, methylpyrazine, ethylpyrazine, 2,3-dimethylpyrazine, 2,5-dimethylpyrazine, 2,6-dimethylpyrazine, 2-ethyl-5-methylpyrazine, and 3-ethyl-2,5-dimehtylpyrazine, see FIGS. 7, 12 and 13 and Table 9) and dividing by the area content of maltol (see Table 10), the ratio for each of the PB Bite and PBB Bite with bacon inclusions was >200 (see FIG. 8). A total of 8 pyrazines was used for ratio calculations (n=9 for PB and PBB, n=3 for C1, C2, C3, C4).

The PB Bite and PBB Bite with bacon inclusions of the invention were also enriched in 4-methylthiazole. Taking the area content ratio of 4-methylthiazole to acetoin, the PB Bite and PBB Bite with bacon inclusions had a ratio of >0.80 (see Table 10, FIG. 9).

TABLE 9
Average pyrazine peak area content for each product tested.

| Area Content (×10⁵) | PB | PBB | C1 | C2 | C3 | C4 |
|---|---|---|---|---|---|---|
| acetylpyrazine | 1.08 | 1.03 | 48.7 | 0.383 | 0.024 | 0.000 |
| ethylpyrazine | 60.4 | 49.5 | 0.399 | 11.6 | 1.84 | 1.20 |
| methylpyrazine | 356 | 297 | 3.25 | 143 | 8.85 | 1.09 |
| 2,3-dimethylpyrazine | 16.1 | 13.1 | 0.294 | 5.50 | 1.03 | 0.000 |
| 2,5-dimethylpyrazine | 181 | 152 | 1.30 | 63.9 | 16.5 | 0.373 |
| 2,6-dimethylpyrazine | 127 | 101 | 2.14 | 152 | 9.88 | 52.8 |
| 2-ethyl-5-methylpyrazine | 44.0 | 37.3 | 0.355 | 4.98 | 3.77 | 0.000 |
| 3-ethyl-2,5-dimethylpyrazine | 34.3 | 27.0 | 0.155 | 4.49 | 4.20 | 0.000 |
| Sum Pyrazines | 819 | 677 | 56.6 | 386 | 46.1 | 55.5 |

TABLE 10
Average area content for volatile compounds that define the
PB and PBB aroma. Pyrazine sum of the area content comes from
Table 9 (n = 9 for PB and PBB, n = 3 for C1, C2, C3, C4).

| | | | | | Area Content Ratio | |
|---|---|---|---|---|---|---|
| | Area Content (×10⁵) | | | | | 4- |
| | pyrazines | 4- | | | pyrazines | methylthiazole / |
| Product | sum | methylthiazole | maltol | acetoin | sum /maltol | acetoin |
| PB | 779 | 2.82 | 6.67 | 2.01 | 123 | 1.40 |
| PBB | 656 | 2.68 | 9.05 | 2.94 | 74.8 | 0.91 |
| C1 | 56.6 | 0.009 | 41.8 | 0.995 | 1.35 | 0.01 |
| C2 | 386 | 0.658 | 35.5 | 44.8 | 10.9 | 0.01 |
| C3 | 46.1 | 0.000 | 2.74 | 19.2 | 16.8 | 0.00 |
| C4 | 55.5 | 0.000 | 7.22 | 0.551 | 7.68 | 0.00 |

With the addition of bacon-containing ingredients, the aroma of the PBB Bite with bacon inclusions of the invention was further defined by the ratio of the area content of (i) p-cresol to eucalyptol and (ii) pyridine to benzyl alcohol (see FIGS. 10 and 11, Table 11). The PBB Bite with bacon inclusions was enriched in p-cresol. The ratio of p-cresol to eucalyptol in the PBB Bite with bacon inclusions was >20 (FIG. 10). The PBB Bite with bacon inclusions was also enriched in pyridine. The ratio of pyridine to benzyl alcohol for the PBB Bite with bacon inclusions was >5.0 (FIG. 11).

TABLE 11
Average area content for volatile compounds that defined the aroma for
PBB (n = 9 for PB and PBB, n = 3 for C1, C2, C3, C4)

| | | | | | Area Content Ratio | |
|---|---|---|---|---|---|---|
| | Area Content (×10⁵) | | | | | pyridine / |
| | p- | | | benzyl | p-cresol / | benzyl |
| Product | Cresol | pyridine | eucalyptol | alcohol | eucalyptol | alcohol |
| PB | 0.019 | 4.56 | 0.100 | 2.31 | 0.187 | 1.97 |
| PBB | 4.71 | 14.9 | 0.127 | 2.05 | 37.1 | 7.28 |
| C1 | 0.278 | 0.000 | 0.017 | 33.5 | 16.7 | 0.000 |
| C2 | 0.000 | 3.41 | 0.303 | 1.02 | 0.000 | 3.34 |
| C3 | 0.009 | 0.757 | 0.350 | 3.18 | 0.025 | 0.238 |
| C4 | 0.449 | 0.000 | 17.7 | 2.27 | 0.025 | 0.000 |

Referring to FIG. 6, disclosed herein is a method of manufacturing the pet treat described herein, including its malleable, texture matrix. Generally, the method includes the steps of:
Blending dry ingredients, e.g., wheat flour, pregelatinized wheat flour, peanut flour, and optionally including an inclusion(s), to form a dry mixture;
mixing wet ingredients, e.g., water, citric acid, humectant, peanut butter, liquid sweetener, preservative, antioxidant, and optionally including a flavorant, to form a wet mixture;
combining the dry mixture with the wet mixture and mixing the combination to form a substantially homogenous dough;
cooking and extruding the substantially homogenous dough in a cooker extruder;
shaping the extruded dough using a die into ropes of the malleable matrix;
portioning the ropes of the malleable matrix to yield pet treats having dimensions selected to fit within the oral cavity of an animal;
cooling the pet treats; and
packaging the cooled pet treats.

As shown in FIG. 6, dry ingredients 62, i.e., wheat flour, pregelatinized wheat flour, peanut flour, are pre-mixed in a mixer 68 capable of mixing dry ingredients and forming dough with the wet ingredients. Inclusions, e.g., meat or meat pieces, textured vegetable protein (TVP), rolled oats, etc., (if included as optional ingredient(s)) are added with the dry mixture in mixer 68. Pre-mixing can occur at an ambient temperature for a time sufficient to blend the dry ingredients thoroughly into a dry mixture. Substantially any mixer machine capable of sufficiently mixing the dry ingredients can be used. Selection of an appropriate mixer is within the ken of an ordinary artisan in this field.

As shown in FIG. 6, the wet ingredients 64, i.e., water, citric acid, humectant, e.g., glycerin, peanut butter, liquid sweetener, e.g., rice syrup, smoke flavor (if included as an optional ingredient), preservative, i.e., potassium sorbate, and antioxidant, i.e., Naturox, are initially mixed separately from the dry ingredients into a slurry in a steam jacketed kettle 66 at a temperature in a range from about 95 to about 120 degrees Fahrenheit to maintain flowability of the wet ingredients. With the steam turned on in the steam jacketed kettle, water and citric acid are first mixed and then the humectant, i.e., glycerin, is added and then the peanut butter. After the peanut butter is added and mixed, the steam is turned off in the steam jacketed kettle 66. The liquid sweetener and flavor, e.g., smoke (if included as an optional agreement), antioxidant, e.g., Naturox, and preservative, e.g., potassium sorbate, are added to the liquid mixture, which is then blended for a time, e.g., about 5 minutes, to thoroughly mix the wet ingredients to form a generally homogenous liquid mixture. Substantially any steam jacketed kettle capable of sufficiently heating and mixing the wet ingredients can be used. Selection of an appropriate steam jacketed kettle is within the ken of an ordinary artisan in this field.

As shown in FIG. 6, the wet mixture 64 is then added to the dry mixture 62 in mixer 68, and the dry mixture 62 and wet mixture 64 are then blended in mixer 68 for enough time to thoroughly blend both into a cohesive substantially homogenous dough, in which the peanut butter is blended throughout.

As shown in FIG. 6, the dough, after being formed in mixer 68, is transferred 70 to an extrusion machine 72. Substantially any transfer apparatus capable of transferring dough to the extrusion machine 72 can be used, e.g., conveyor. Then the dough is placed in the extrusion machine 72, e.g., a cooker extruder, and extruded. Non-limiting examples of extruders include Extrutech 525 running in series with a 6-zone profile and a Bonnot former or single Bonnot cooking extruder. Cooking in the extruder apparatus can occur at a temperature sufficient for a microbial kill step, e.g., from about 194 to about 220 degrees Fahrenheit. Extrusion can occur at pressures from about 40 to about 80 psi. Substantially any extrusion machine capable of extruding the dough can be used. Selection of an appropriate extruder is within the ken of an ordinary artisan in this field, in view of the desired processing capacity of the apparatus and desired temperature of the extrudate.

As shown in FIG. 6, the extruded dough is passed through a die that forms the extruded dough into ropes having a perimeter shape that is approximately that of the desired perimeter shape of the final pet chew, e.g., square, round, rectangular cube, or other shape. The ropes are placed on a cooling conveyor 74. Substantially any cooling conveyor 74 capable of sufficiently cooling the ropes can be used.

As shown in FIG. 6, the cooling conveyor 74 delivers the ropes to the cutter 76. The cutter 76 portions the cooled ropes into slices cut approximately perpendicular to the long axis of the rope into the bite sized pieces, which are operationally efficient (i.e., a square or rectangular cube, etc.). Substantially any cutter apparatus capable of sufficiently cutting the ropes into the target shape, i.e., bite sized pieces, can be used. Selection of an appropriate cutter is within the ken of an ordinary artisan in this field and can include, for example, a guillotine, lawnmower, or other suitable cutter machine.

As shown in FIG. 6, the bite sized pieces are then cooled 78 by a cooler for about 45 minutes and then packaged 80. Such cooling preferably is performed in a controlled environment to effectively reduce the temperature of the bite sized pieces without freezing. Substantially any cooler apparatus capable of cooling the bite sized pieces to a target temperature can be used. Selection of an appropriate cooler apparatus is within the ken of an ordinary artisan in this field and can include, for example, trays, spiral cooler, or another format.

The moisture content of cooled bite sized pieces can be preserved by packaging the bite sized pieces in moisture-retaining packaging, such as any of a wide variety of plastic films, which slow moisture passage across the film. Inclusion of a humectant in the pet treat, such as one or more of those described in the formulas for the pet treat herein, can also inhibit moisture loss from the finished pet treat. The proportions of water and humectant in the final product should be selected in amounts sufficient to confer malleability to the cooled bite sized pieces.

While the subject matter has been disclosed with reference to specific embodiments, it will be apparent that other embodiments and variations can be devised by those skilled in the art without departing from the true spirit and scope of the subject matter described herein. The appended claims include all such embodiments and equivalent variations.

What is claimed is:

1. An animal consumable, the animal consumable comprising a malleable matrix, wherein the malleable matrix comprises:
pregelatinized wheat flour at about 5-15 wt % of the malleable matrix;
wheat flour at about 15-30 wt % of the malleable matrix;
liquid sweetener at about 2-11 wt % of the malleable matrix;
peanut butter at about 9-18 wt % of the malleable matrix;
peanut flour at about 0-25 wt % of the malleable matrix;
a humectant at about 15-26.5 wt % of the malleable matrix;
wherein oil of the peanut butter is retained within the malleable matrix and the malleable matrix has low surface oil residue and low surface adhesion.

2. The animal consumable of claim 1 wherein the ratio of pregelatinized wheat flour to liquid sweetener is in a range of about 2.5:1 to about 0.8:1.

3. The animal consumable of claim 1 wherein the ratio of humectant to wheat flour is in a range of about 1:0.7 to about 1:1.4.

4. The animal consumable of claim 1 wherein the malleable matrix comprises a moisture content of up to about 24% by weight of the malleable matrix.

5. The animal consumable of claim 4 wherein the malleable matrix comprises water activity in a range from about 0.65 to about 0.73.

6. The animal consumable of claim 1 wherein the malleable matrix has a hardness measured at a peak force of about 0.6 grams of positive force.

7. The animal consumable of claim 1 wherein the low surface adhesion is measured at a negative peak force of about 4655 grams.

8. The animal consumable of claim 1 wherein the oil of the peanut butter is retained within the malleable matrix by native starch of the wheat flour or modified starch of the pregelatinized wheat.

9. The animal consumable of claim 1 wherein the malleable matrix comprises at least one inclusion.

10. The animal consumable of claim 1 wherein the malleable matrix comprises at least two volatile compounds selected from group consisting of pyrazines, 4-dimethylthiazole, maltol, acetoin, p-cresol, pyridine, eucalyptol, and benzyl alcohol.

11. The animal consumable of claim 10 wherein a ratio of area content of pyrazines to maltol is greater than 200.

12. The animal consumable of claim 10 wherein a ratio of area content of 4-methylthiazole to acetoin is greater than 0.8.

13. The animal consumable of claim 10 wherein a ratio of area content of p-cresol to eucalyptol is greater than 20.

14. The animal consumable of claim 10 wherein a ratio of area content of pyridine to benzyl alcohol is greater than 5.

15. A composition capable of emitting a peanut-like aroma after exposure to heat and pressure in manufacturing, the composition comprising native and modified wheat starch, a liquid sweetener, peanut butter, peanut flour, and a humectant, wherein the composition has a texture matrix in the form of a pet consumable, and wherein the composition is enriched in volatile compounds.

16. The composition of claim 15 wherein the volatile compounds are selected from the group consisting of pyrazines, 4-dimethylthiazole, maltol, and acetoin.

17. The composition of claim 16 wherein the pyrazines are selected from the group consisting of acetylpyrazine, ethylpyrazine, methylpyrazine, 2,3-dimethylpyrazine, 2,5-dimethylpyrazine, 2,6-dimethylpyrazine, 2-ethyl-5-methylpyrazine, and 3-ethyl-2,5-dimethylpyrazine.

18. The composition of claim 16 wherein a ratio of area content of pyrazines to maltol is greater than 200.

19. The composition of claim 16 wherein a ratio of area content of 4-methylthiazole to acetoin is greater than 0.8.

20. The composition of claim 15 wherein the composition comprises bacon inclusions and a flavorant.

21. The composition of claim 20 wherein the volatile compounds are selected from the group consisting of p-cresol, pyridine, eucalyptol, and benzyl alcohol.

22. The composition of claim 20 wherein a ratio of area content of p-cresol to eucalyptol is greater than 20.

23. The composition of claim 20 wherein a ratio of area content of pyridine to benzyl alcohol is greater than 5.

24. A method of imparting a peanut-like aroma to a thermally treated food composition that is malleable, the method comprising:
blending dry ingredients comprising wheat flour, pregelatinized wheat flour, peanut flour to form a dry mixture;
mixing wet ingredients comprising water, humectant, peanut butter, and liquid sweetener to form a wet mixture;
combining the dry mixture and the wet mixture with a mixer to create a substantially homogenous dough;
subjecting the substantially homogenous dough to heat treatment in a range of about 194 to about 220 degrees Fahrenheit in a cook cycle and extruding cooked dough to produce the food composition that is enriched in volatile compounds and exhibits the peanut-like aroma.

25. The method of claim 24 wherein the ratio of pregelatinized wheat flour to liquid sweetener is in a range of about 2.5:1 to about 0.8:1.

26. The method of claim 24 where in the ratio of humectant to wheat flour is in a range of about 1:0.7 to about 1:1.4.

27. The method of claim 24 wherein the food composition comprises a moisture content of up to about 24% by weight of the food composition.

28. The method of claim 24 wherein the volatile compounds are one or more volatile compounds selected from the group consisting of pyrazines, 4-dimethylthiazole, maltol, and acetoin.

29. The method of claim 28 wherein a ratio of area content of pyrazines to maltol is greater than 200.

30. The method of claim 28 wherein a ratio of area content of 4-methylthiazole to acetoin is greater than 0.8.

31. The method of claim 28 wherein the volatile compounds are any one or more volatile compounds selected from the group consisting of p-cresol, pyridine, eucalyptol, and benzyl alcohol.

32. The method of claim 28 wherein the method comprises portioning the food composition into pieces of the food composition.

33. The method of claim 32 wherein the pieces of the food composition are shelf stable.
